(19) United States
(12) Patent Application Publication
(10) Pub. No.: US 2017/0218856 A1
(43) Pub. Date: Aug. 3, 2017

(54) NON-CONTACT SENSOR DEVICE FOR ELECTRIC THROTTLE

(71) Applicant: YOW JUNG ENTERPRISE CO., LTD., KAOHSIUNG CITY (TW)

(72) Inventor: SHUN-CHI HUANG, KAOHSIUNG CITY (TW)

(21) Appl. No.: 15/014,128

(22) Filed: Feb. 3, 2016

(51) Int. Cl. F02D 11/10; G01D 5/14; F02D 41/30; F02D 9/08

(52) U.S. Cl. CPC F02D 11/10; F02D 9/08; G01D 5/145; F02D 41/3005

(57) ABSTRACT

This invention is related to a non-contact sensor device for electric throttle, comprising a body and a cover. A drive assembly is set in the body and has a shaft corresponded to the on/off state of a throttle valve. An adaptor is installed on the shaft, and a magnet element is set on the adaptor. A Hall element is set on the cover to correspond to the magnet element for detecting the rotation angle of the shaft, thereby knowing the air inflow value and the open angle of the throttle valve to control the fuel injection of fuel-air mixture.

### BACKGROUND OF THE INVENTION

Field of the Invention

The present invention relates to a non-contact sensor device for electric throttle. More particularly, a non-contact sensor device detects the open angle of the throttle valve via the change of a magnetic field for controlling the fuel injection of fuel-air mixture.

Description of Related Art

Fresh air goes into the engine through the air inlet and the air cleaner, then into the throttle known as accelerator. The accelerator is only one mechanism controlled by the driver in whole engine. In a carburetor system, the carburetor is controlled by the driver; however, in the fuel injection system, the throttle valve is substituted for the carburetor. After use of the fuel injection system, the fuel is injected directly ahead the throttle, so the fuel and the air are not mixed in the throttle. But in order to control the mix of the fuel and the air accurately, the mechanism of the fuel injection system is not simpler than that of the carburetor system.

The traditional typical throttle comprises a main air inlet and a throttle valve, and the throttle valve is controlled by a spring. Before the driver presses the accelerator pedal, the throttle valve is closed, so the air is obstructed. When the driver presses the accelerator pedal, the throttle wire pulls the spring of the throttle valve to open the throttle valve for air into the engine through the main air inlet. Besides, the open angle of the throttle valve is transformed into an electrical signal by a throttle position sensor (TPS), so the amount of fuel injection is controlled by the engine control unit (ECU) according to the electrical signal.

The traditional throttle position sensor uses a variable resistor to detect and control the throttle position. Its basic principle is described below. The tradition throttle position sensor is a rotational variable resistor, when rotation, the resistance is changed, so that the voltage is also changed, thereby showing the position of the throttle. Accordingly, is the throttle position sensor is connected to one end of the shaft of the throttle, when the throttle valve is rotated the throttle position sensor is also rotated, thereby determining the position of the throttle valve and the amount of the air inflow according to the changed voltage which is resent to the electronic control module (ECM). However, the detection method via the variable resistor is a contact-type detection, as time goes by, it is damaged easily and the accuracy is decreased.

### SUMMARY OF THE INVENTION

Therefore, the object of the present invention is related to a non-contact sensor device for electric throttle. More particularly, a non-contact sensor device detects the open angle of the throttle valve via the change of a magnetic field for controlling the fuel injection of fuel-air mixture.

For the above object, a non-contact sensor device for electric throttle is disclosed, which comprises a body and a cover. A drive assembly is set in the body and has a shaft corresponded to the on/off state of a throttle valve. An adaptor is installed on the shaft, and a magnet element is set on the adaptor. A Hall element is set on the cover to correspond to the magnet element for detecting the rotation angle of the shaft, thereby knowing the air inflow value and the open angle of the throttle valve to control the fuel injection of fuel-air mixture.

According to an embodiment, the magnet element of the foregoing non-contact sensor device for electric throttle has N-S pole to correspond to the Hall element at the cover, thereby transforming the change of the magnetic field into the change of the output voltage by the Hall element to sensor the rotation angle of the shaft.

According to the above description and embodiments, the non-contact sensor device for electric throttle of the present invention has the advantages as following:

1. In the non-contact sensor device for electric throttle of the present invention, the non-contact detection is via the magnet element on the adaptor coupled to the Hall element, thereby elongating the use life of the non-contact sensor device for electric throttle of the present invention.

2. The non-contact sensor device for electric throttle of the present invention is assembled easily and detects accurately.

### BRIEF DESCRIPTION OF THE DRAWINGS

FIG. 1 is a partial exploded view of a non-contact sensor device for electric throttle according to an embodiment of the present invention;

FIG. 2 is an assembled view of a non-contact sensor device for electric throttle according to an embodiment of the present invention;

FIG. 3 is a sectional view of a non-contact sensor device for is electric throttle according to an embodiment of the present invention; and

FIG. 4 is a top view of a non-contact sensor device for electric throttle according to another embodiment of the present invention.

### DETAILED DESCRIPTION OF THE PREFERRED EMBODIMENT

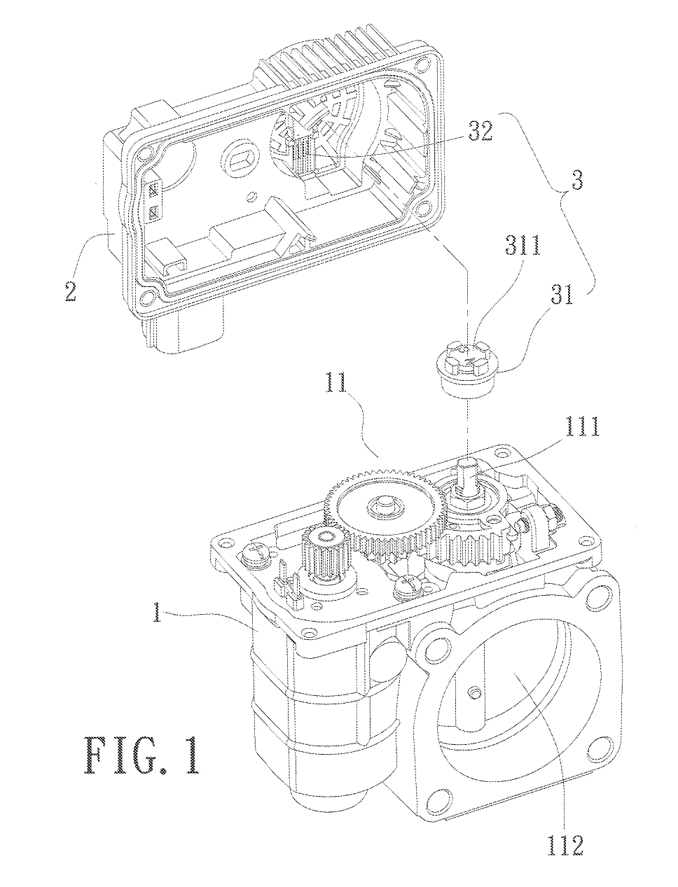

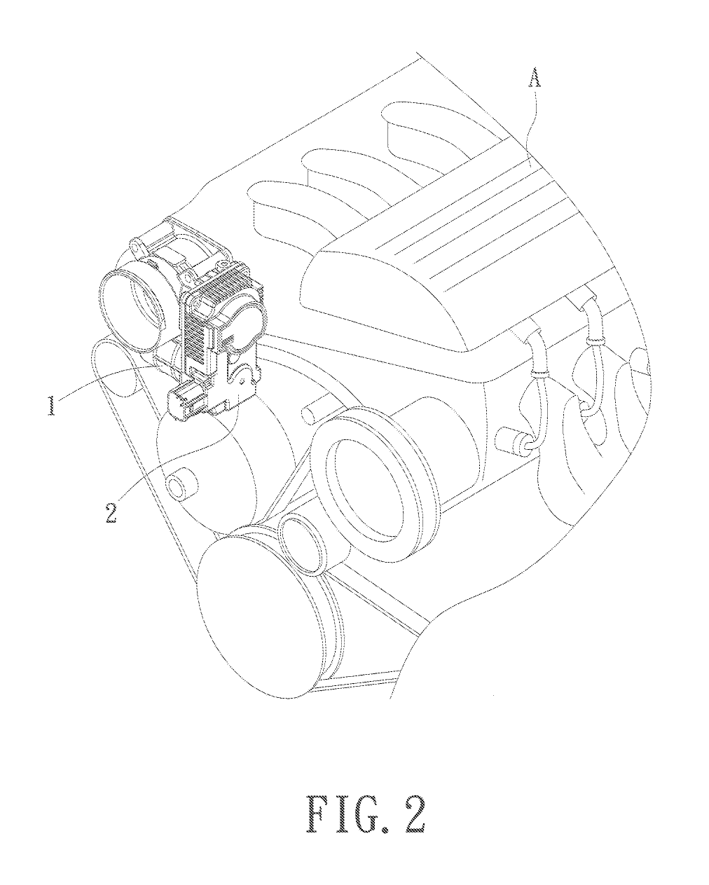

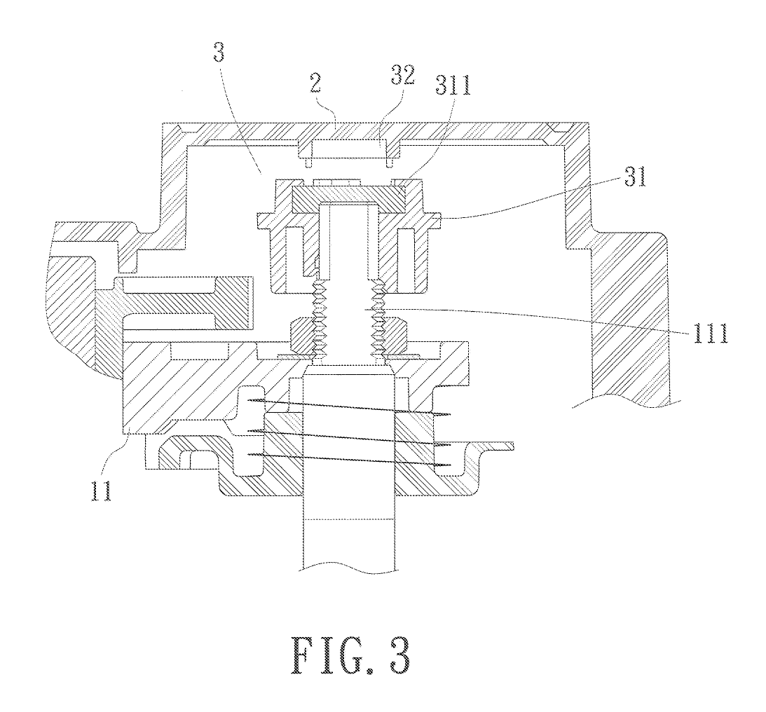

Please refer to FIG. 1 to FIG. 3, which are a partial exploded view, an assembled view, and a sectional view of a non-contact sensor device for electric throttle according to an embodiment of the present invention, respectively. The non-contact sensor device for electric throttle comprises a body 1 and a cover 2 for covering on the body 1. A drive assembly 11 is set in the body 1 and formed with a shaft 111 which is correspond to the on/off state of a throttle valve 112. A sensor device 3 is set on the shaft 111 for detecting the on/off state of the throttle valve 112.

The sensor device 3 comprises an adaptor 31 installed on the shaft 111, a magnet element 311 with N-S pole set on the top surface of the adapter 31, and a Hall element 32 set on the cover 2 and corresponded to the magnet element 311 to form a non-contact response for detecting the on/off state of the throttle valve 112.

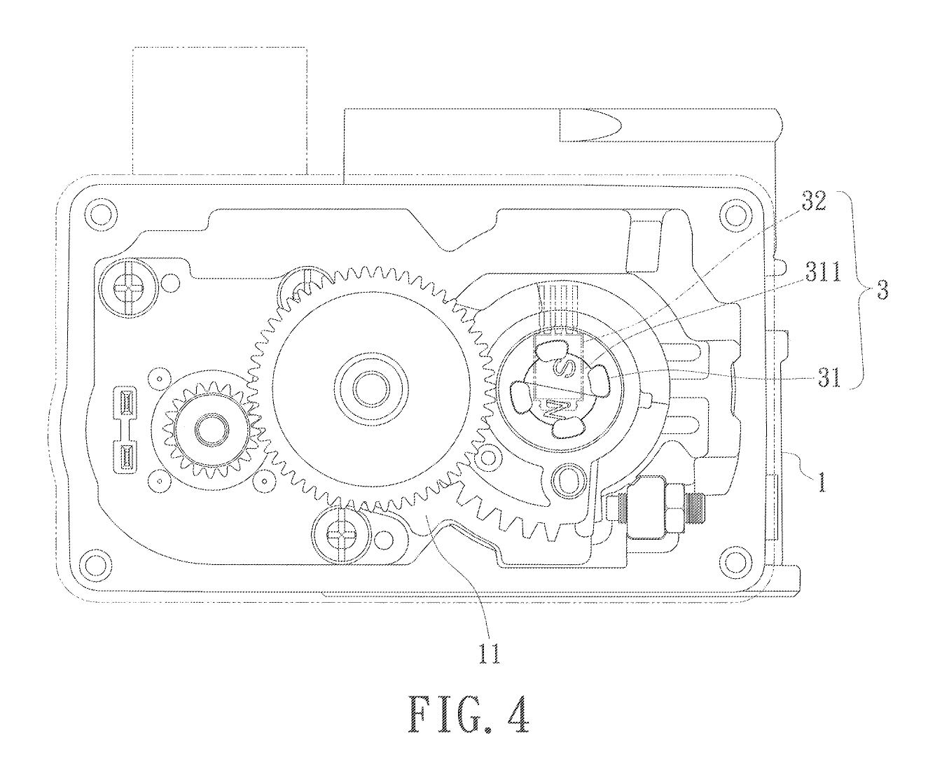

Please refer to FIG. 1 to FIG. 4. When the non-contact sensor device for electric throttle is assembled, the body 1 is assembled at one side of the engine A, and the drive assembly 11 is set in the body 1. The structure of the drive assembly 11 is not the characteristics of the present invention, it is not described here. The adaptor 31 is installed on the shaft 111 of the drive assembly 11, and the magnet element 311 is set on the top surface of the adaptor 31. The Hall element 32 is set on the cover 2 and corresponded to the magnet element 311.

When the driver presses the accelerator pedal, the drive assembly 11 drives the shaft 111 rotate to open the throttle valve 112, wherein the open angle of the throttle valve 112 impacts on the amount of air inflow and the fuel injection. Therefore, the rotated angle is detected by the Hall element 32 corresponded to the magnet element 311 on the adaptor 31, so the open angle of the throttle valve 112 and the amount of the air inflow is known by the property of the Hall element 32 which transforms the change of the magnetic field to the change of the output voltage, thereby controlling the fuel injection of fuel-air mixture.

According to the above description and embodiments, the non-contact sensor device for electric throttle of the present invention has the advantages as following:

1. In the non-contact sensor device for electric throttle of the present invention, the non-contact detection is via the magnet element on the adaptor coupled to the Hall element, thereby elongating the use life of the non-contact sensor device for electric throttle of the present invention.

2. The non-contact sensor device for electric throttle of the present invention is assembled easily and detects accurately.

What is claimed is:

1. A non-contact sensor device for an electric throttle, comprising:
a cover, and
a body, covered by the cover, the body comprising:
a drive assembly, set in the body and formed with a shaft corresponded to the on/off state of a throttle valve ; and
a sensor device, set on the shaft for detecting the on/off state of the throttle valve, the sensor device comprising:
an adaptor, installed on the shaft;
a magnet element with N-S pole, set on the top surface of the adapter; and
a Hall element, set on the cover and corresponded to the magnet element to form a non-contact response for detecting the on/off state of the throttle valve.
